(19) United States
(12) Patent Application Publication
(10) Pub. No.: US 2015/0052725 A1
(43) Pub. Date: Feb. 26, 2015

(54) ELASTIC AVERAGING ALIGNMENT SYSTEM AND METHOD

(71) Applicant: GM Global Technology Operations LLC, Detroit, MI (US)

(72) Inventors: Steven E. Morris, Fair Haven, MI (US); Jennifer P. Lawall, Waterford, MI (US)

(73) Assignee: GM Global Technology Operations LLC, Detroit, MI (US)

(21) Appl. No.: 13/973,587

(22) Filed: Aug. 22, 2013

(51) Int. Cl. B60R 13/02

(52) U.S. Cl. CPC B60R 13/0206
USPC 29/407.09

(57) ABSTRACT

An elastic averaging alignment system includes a first component having at least one wall member defining a thickness between opposing faces thereof, and a second component having a component surface with at least one receiver protruding therefrom, each of the at least one receiver having a first receiver wall with a first engagement surface and a second receiver wall with a second engagement surface, the first and the second engagement surfaces are positioned a distance apart less than the thickness such that at least one of the first and the second receiver walls elastically deform in response to having the at least one wall member positioned between the first and the second receiver walls.

### FIELD OF THE INVENTION

The subject invention relates to the art of alignment systems and, more particularly, to an elastic averaging alignment system, and even more particularly to an elastic averaging alignment system for motor vehicle components.

### BACKGROUND

Currently, components, particularly vehicular components such as those found in automotive vehicles, which are to be mated together in a manufacturing process are mutually located with respect to each other by features that are oversized and/or undersized to provide spacing to freely move the components relative to one another to align them. One example includes two-way and/or four-way male alignment features, typically upstanding bosses, which are received into corresponding female alignment features, typically apertures in the form of holes or slots. There is a clearance between the male alignment features and their respective female alignment features which is predetermined to match anticipated size and positional variation tolerances of the male and female alignment features as a result of manufacturing (or fabrication) variances. As a result, significant positional variation can occur between the mated first and second components that contribute to the presence of undesirably large variation in their alignment, particularly with regard to the gaps and spacing between them. In the case where these misaligned components are also part of another assembly, such misalignments can also affect the function and/or aesthetic appearance of the entire assembly. Regardless of whether such misalignment is limited to two components or an entire assembly, it can negatively affect function and result in a perception of poor quality. The industry is therefore receptive to new systems and methods for improving alignment of components to one another.

### SUMMARY OF THE INVENTION

In one exemplary embodiment of the invention disclosed herein is an elastic averaging alignment system. The system includes a first component having at least one wall member defining a thickness between opposing faces thereof, and a second component having a component surface with at least one receiver protruding therefrom, each of the at least one receiver having a first receiver wall with a first engagement surface and a second receiver wall with a second engagement surface, the first and the second engagement surfaces are positioned a distance apart less than the thickness such that at least one of the first and the second receiver walls elastically deform in response to having the at least one wall member positioned between the first and the second receiver walls.

In another exemplary embodiment of the invention disclosed herein is a method of aligning a first component with a second component. The first component comprising at least one wall member having a thickness between opposing faces and extending along a first longitudinal axis, the second component comprising a component surface and at least one receiver that is elastically deformably protruding from the component surface, each receiver comprising a first receiver wall protruding from the component surface having a first engagement surface and an opposing second receiver wall extending from the component surface having a second engagement surface. The first engagement surface is spaced from and opposing the second engagement surface by a distance that provides an interference condition between the first and second engagement surfaces and the opposing faces of the wall member and elastic deformation of the first and second deformable receiver wall members upon insertion of the wall member between the first and second engagement surfaces. The method includes positioning the at least one the wall member of the first component proximate the at least one receiver of the second component, inserting the wall member between the first and second receiver walls by moving a free end of the wall member toward the component surface and creating the interference condition between the first and second engagement surfaces and the opposing faces of the wall members. Additionally, elastically deforming at least one of the first and second receiver walls, and aligning the first component relative to the second component by the elastic deformation of the first and second receiver walls to obtain a predetermined position of the first component relative to the second component by elastic averaging.

In yet another exemplary embodiment of the invention disclosed herein is a motor vehicle trim alignment system. The system includes a first trim component comprising at least one wall member having a thickness defined between opposing faces and extending along a first longitudinal axis, and a second trim component comprising a component surface and at least one receiver protruding from the component surface, each receiver comprising a first receiver wall protruding from the component surface having a first engagement surface and an opposing second receiver wall member extending from the component surface having a second engagement surface, the first engagement surface spaced from and opposing the second engagement surface by a distance that provides an interference condition between the first and second engagement surfaces and the opposing faces of the wall member and elastic deformation of the first and second receiver walls upon insertion of the wall member between the first and second engagement surfaces.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 depicts a plan view of a first component and second component with the second component aligned in an elastically averaged predetermined position relative to the first component;

FIG. 2 depicts a perspective view of the first component of FIG. 1;

FIG. 3 depicts a plan view of the second component of FIG. 1;

FIG. 4 is a perspective view of an exemplary embodiment of a receiver of the second component disclosed herein;

FIG. 5 is a front view of the receiver of FIG. 4;

FIG. 6A is a perspective view of a second exemplary embodiment of a receiver of the second component disclosed herein;

FIG. 6B is a cross-sectional view taken at arrows 6B-6B in FIG. 6A;

FIG. 7A is a front view of another exemplary embodiment of a receiver disclosed herein;

FIG. 7B is a front plan view of another exemplary embodiment of a receiver disclosed herein;

FIG. 7C is another exemplary embodiment of a receiver disclosed herein;

FIG. 7D is another exemplary embodiment of a receiver disclosed herein; and

FIG. 7E another exemplary embodiment of a receiver disclosed herein.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

In accordance with an embodiment of the invention an elastic averaging alignment system that utilizes alignment features comprising wall members and elastically deformable protruding receivers is disclosed. This system utilizes elastic averaging technology in a rib-to-wall design, i.e. where two elastically deformable walls of the receiver are formed on one component and create a slot for a substantially rigid or non-deformable rib or wall formed on another component to be inserted between them. The two elastically deformable walls deform, such as by deflection or bending, as the substantially rigid rib is slidably inserted between them. The spacing of the surfaces of the two deformable walls that engage the rib (i.e. engagement surfaces) and the thickness of the rib are selected to provide an interference condition as the rigid rib is inserted between the engagement surfaces. The engagement surfaces may also include tapered lead-in portions to facilitate the initial capture and insertion of the rigid rib, and substantially planar portions that engage the rigid rib and cause the walls to elastically deform for the interference condition. The ribs and receivers of this alignment system may be spaced apart on the surfaces of the components of interest and oriented so as to provide two-way or four-way elastic averaging. This alignment system advantageously provides the benefits of elastic averaging, including reduced variation in the alignment of the components, including gap and spacing variations between the components around their peripheries or across their surfaces, and can be utilized with existing components that already include ribs or walls, or newly designed components where the addition of such features is either necessary or desirable.

The elastically deformable walls of the receiver are configured to interfere with a feature or features of the mating part or member that is substantially rigid (i.e., not elastically deformable) relative to the walls. The over-constrained interfaces (i.e. due to the interference) will average each individual positional error of each elastically averaged receiver. These elastically averaged alignment features allow elastic averaging of the positional errors of the component that includes the receiver or receivers relative to the component having the rigid ribs or walls and may be used to provide a more consistent and precise alignment and fit of the respective components, for example. This improved alignment and fit may be realized simply by assembly of the components using these features, without the need for manual intervention by an operator to fit or obtain a desired alignment of the components relative to one another, i.e. the components become self-aligning.

As the components are assembled the elastically deformable walls that define the slots are elastically deformed. The deformable walls comprise cantilevered beam portions of the respective component. These cantilevered beams are elastically deformed by bending away from one another along the height of the deformable walls from the end that is attached to the surface of the respective component to their free ends upon insertion of the rigid ribs. Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, the disclosure of which is incorporated by reference herein in its entirety. The embodiments disclosed herein provide the ability to convert an existing component that is not compatible with the described elastic averaging principles to an assembly that does facilitate elastic averaging and the benefits associated therewith.

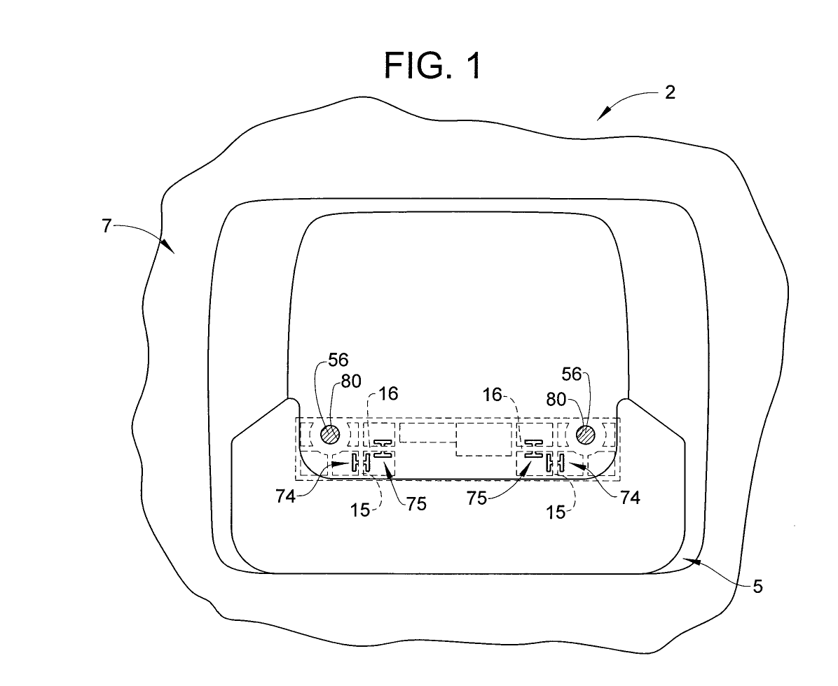

An elastic averaging alignment system in accordance with an exemplary embodiment is indicated generally at 2 in FIG. 1. In the exemplary embodiment shown, the elastic averaging alignment system 2 is employed to join motor vehicle trim components. While the alignment system 2 is illustrated, for example, using vehicle trim components, it may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various other interior, exterior and under hood vehicular components and applications.

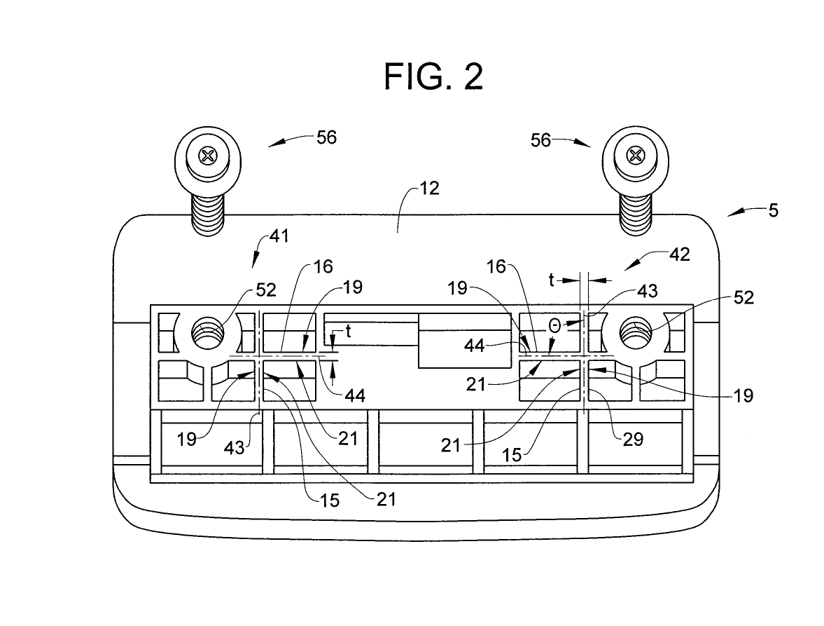

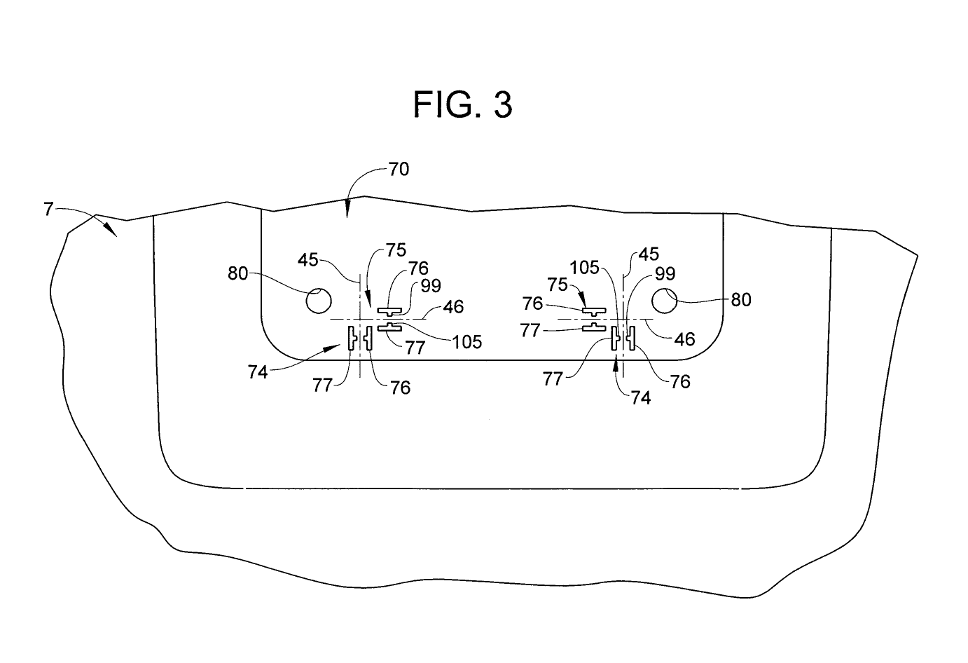

Referring to FIGS. 1-3, the system 2 includes, a first component 5 (FIG. 2) that is aligned and fastenable to a second component 7 (FIG. 3). Note that in FIG. 1 the first component 5 is shown reversed and aligned with the second component 7 such that a surface 12 of the first component 5 is facing a surface 70 of the second component 7. The first component 5 may be a first trim component shown as a door handle for a compartment of a motor vehicle, such as a glove box door handle, for example. The first component 5 has at least one wall member 15, 16 with a plurality being illustrated in the Figure. The wall members 15, 16 have a thickness (t) defined as a dimension between opposing faces 19, 21 thereof. One or more receivers 74, 75 protrude from the surface 70 of the second component 7 with a plurality being shown. Each of the receivers 74, 75 has a first receiver wall 76 with a first engagement surface 99 and a second receiver wall 77 with a second engagement surface 105. The engagement surfaces 99, 105 being positioned a distance apart less than the thickness (t) such that the first and the second receiver walls 76, 77 elastically deform in response to the wall member 15, 16 being positioned between the first engagement surface 99 and the second engagement surface 105. The wall member 15 may be described as projecting generally perpendicularly from the surface 12, and may also be described as extending from a first end 41 to a second end 42 where it is attached to the structure of the first component 5, such as another wall section, for example.

In one embodiment spacing of the plurality of wall members 15 and 16 will be selected to provide a desired degree of elastic averaging of positional variation for the first component 5 relative to the second component 7. For example, the wall members 15, 16 may be spaced over the entire surface 12 of the first component 5 as shown in FIG. 2, or may be concentrated in a portion or portions of the surface of the first component, depending on where the elastic averaging of the positional variation relative to the second component 7 is desired. The plurality of wall members 15 have first longitudinal axes 43 that are aligned substantially parallel to one another and the plurality of wall members 16 have second longitudinal axes 44 that are aligned substantially parallel to one another. The plurality of first longitudinal axes 43 and second longitudinal axes 44 are not parallel to one another and may be aligned at any non-zero angle (θ) to one another, including any acute or obtuse angle, such as angles ranging from about 30 to 150 degrees, and more particularly about 60 to about 120 degrees, and even more particularly about 90 degrees so that the plurality of first longitudinal axes 43 are substantially perpendicular to the plurality of second longitudinal axes 44.

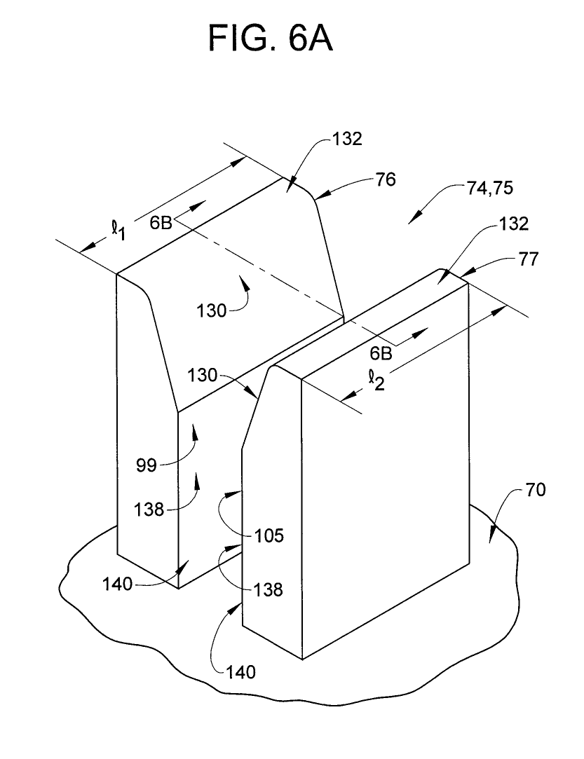

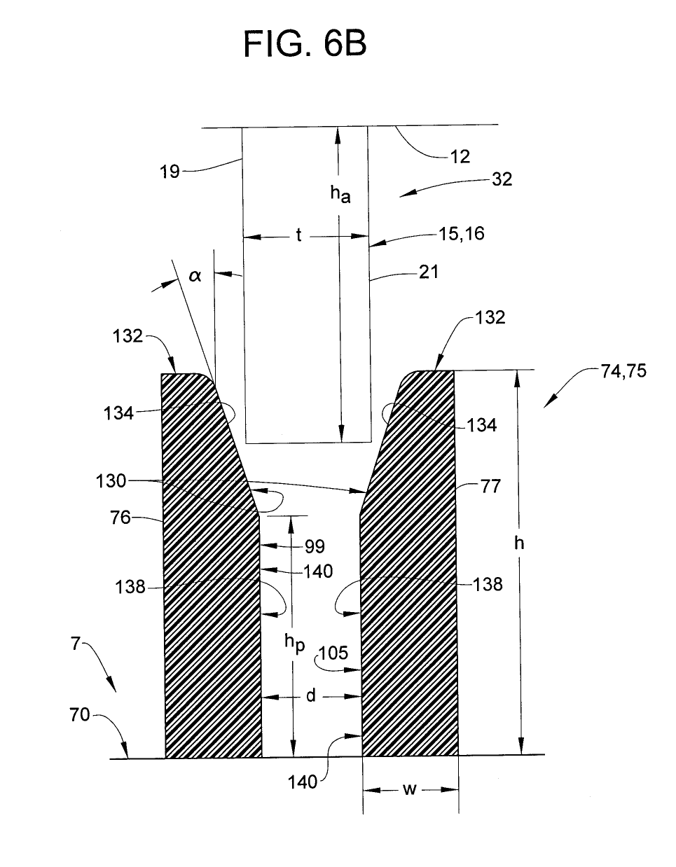

Referring to FIG. 6B, the wall members 15, 16 include generally rectangular cross-sections including a height (hₐ) and the thickness (t). The height (hₐ) and thickness (t) of the wall members 15, 16 may be the same or different and will be selected to provide an interference condition and elastic deformation of mating receivers 74, 75 respectively. The height (hₐ) is configured so that it is insertable into and engagable with the mating receiver 74, 75 and the thickness (t) configured to provide a predetermined amount of elastic deformation of the receiver 74, 75. The wall members 15, 16 are substantially rigid members. As used herein, the term substantially rigid members means that wall members 15, 16 are substantially not elastically deformable, particularly relative to the elastically deformable receivers 74, 75. This means that as the wall members 15, 16 engage the receivers 74, 75 as described herein; it is the receivers 74, 75 that undergo most of the elastic deformation to provide elastic averaging and that the wall members 15, 16 undergo comparatively little elastic deformation. In various embodiments, for example, the wall members 15, 16 undergo about 20 percent or less of the elastic deformation of the alignment system 2, and more particularly about 10 percent or less, and even more particularly about 5 percent or less.

In one embodiment, the second component 7, as illustrated best in FIG. 3, takes the form of a second trim component or compartment door panel for a motor vehicle. The elastically deformable receivers 74, 75 protrude from the surface 70 and are spaced from one another. The spacing of the receivers 74, 75 is configured to provide the desired degree of elastic averaging of positional variation for the second component 7 relative to the first component 5. In correspondence with and similar to the wall members 15, 16, the plurality of receivers 74, 75 may be spaced over the entire surface 70 of the second component 7, for example, or may be concentrated in a portion or portions of the surface 70, depending on where the elastic averaging of the positional variation relative to the first component 5 is desired. The plurality of receivers 74 have first longitudinal receiver axes 45 that are aligned substantially parallel to one another and the receivers 75 have second longitudinal receiver axes 46 that are aligned substantially parallel to one another. The plurality of first longitudinal receiver axes 45 and second longitudinal receiver axes 46 are not parallel to one another and may, similar to and in correspondence with first longitudinal axes 43 and second longitudinal axes 44, be aligned at any non-zero angle (θ) to one another, including any acute or obtuse angle, such as angles ranging from about 30 to 150 degrees, and more particularly about 60 to about 120 degrees, and even more particularly about 90 degrees so that the plurality of first longitudinal receiver axes 45 and first longitudinal axes 43 are substantially parallel to one another, and are substantially perpendicular to the plurality of second longitudinal axes 44 and second longitudinal receiver axes 46. The plurality of receivers 74, 75 includes the receiver walls 76, 77 that are spaced apart from one another.

The plurality of receivers 74, including second receiver walls 76, 77 are configured to engage and retain the plurality of first alignment wall members 15, as will become more fully evident below, and provide two-way elastically averaged alignment, i.e. alignment in one direction perpendicular to the axes 43, for example. The receivers 75, including the first receiver walls 76, 77 are configured to engage and retain the plurality of second alignment wall members 16, as will also become more fully evident below and provide two-way elastically averaged alignment, i.e. alignment in one direction perpendicular to the axes 44, for example. The combination of receivers 74, 75 and their respective alignment wall members provide four-way alignment, i.e., alignment in two directions perpendicular to the axes 43 and 44, for example.

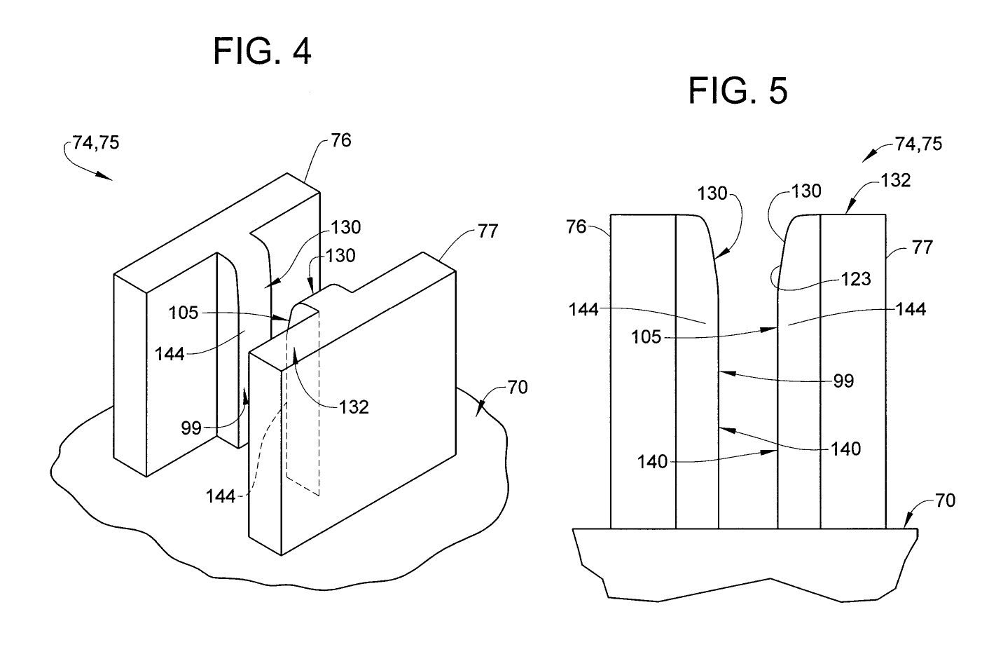

Referring to FIGS. 4 and 5, in one embodiment the receivers 74, 75 are similarly formed. The receiver walls 76, 77 may be detachably mounted to the surface 70. In another embodiment, the receiver walls 76, 77 may also be formed, such as by various types of molding, onto the second component 7, and more particularly may be formed on the surface 70 of the second component 7. In yet another embodiment, the receiver walls 76, 77 may be integrally formed with the second component 7 on the surface 70.

The first receiver wall 76 includes a first engagement surface 99. Likewise, the second receiver wall 77 includes a second engagement surface 105. The first engagement surface 99 is spaced from and opposing the second engagement surface 105 by a distance (d) (FIG. 6B) that provides an interference condition between the first and second engagement surfaces 99, 105 and the faces 19, 21 that define the thickness (t) of the wall members 15, 16, as illustrated, for example, in FIG. 6B. The interference fit causes an elastic deformation of the receiver walls 76, 77 upon insertion of the wall members 15, 16 between the first and second engagement surfaces 99, 105.

In one embodiment, as illustrated in FIGS. 6A and 6B, the first engagement surface 99 extends along an entire length (l₁) of the receiver wall 76. Likewise, the second engagement surface 105 extends along the entire length (l₂) of the receiver wall 77. The receiver wall 76 is formed from a first compliant material having a first modulus of elasticity. The receiver wall 77 is formed from a second compliant material having a second modulus of elasticity. The first and second materials may be the same materials or different materials and the first and second moduli of elasticity may be the same or different. The receiver walls 76, 77 are elastically deformable as described herein and are selected to be substantially more flexible (i.e. less rigid) than the corresponding alignment wall members 15, 16. In this embodiment, for example, the lengths (l₁, l₂) of the first and second engagement surfaces 99, 105 will be selected, in view of the elastic deformation of the receiver walls 76, 77 and the pressure against these walls 76, 77 resulting from the insertion of the wall member 15, 16, and other factors such as the coefficient of sliding friction of the respective contact surfaces, to allow the alignment wall member 15, 16 to be slidably inserted between the receiver walls 76, 77 toward the surface 70 of the second component 7.

Referring again to FIGS. 1-3, the first component 5 in the embodiment illustrated has threaded openings 52 that are threadably engagable by fasteners 56. Openings 80 through the second component 7 are alignable with the openings 52 such that the fasteners 56 can extend through the openings 80 when threadably engaged with the openings 52. The openings 80 are sized larger than the fasteners 56 to allow alignment between the components 5, 7 to be controlled by engagement of the wall members 15, 16 into their respective receivers 76, 77 and not by contact between the fasteners 56 and the openings 80.

In one embodiment, at least one of the first engagement surface 99 or the second engagement surface 105 comprises a lead-in portion 130 (FIGS. 6A and 6B) that tapers inwardly from a free first end 132 of the receiver wall 76, 77 with which it is associated toward the opposing engagement surface 99, 105. In another embodiment, both the first engagement surface 99 and the second engagement surface 105 include the lead-in portion 130. In one embodiment the first engagement surface 99 and the second engagement surface 105 include a planar engagement surface 140. The lead-in portion 130 adjoins an engagement portion 138 of the respective engagement surface 99, 105 that extends substantially perpendicular from the surface 70 to the lead-in portion 130.

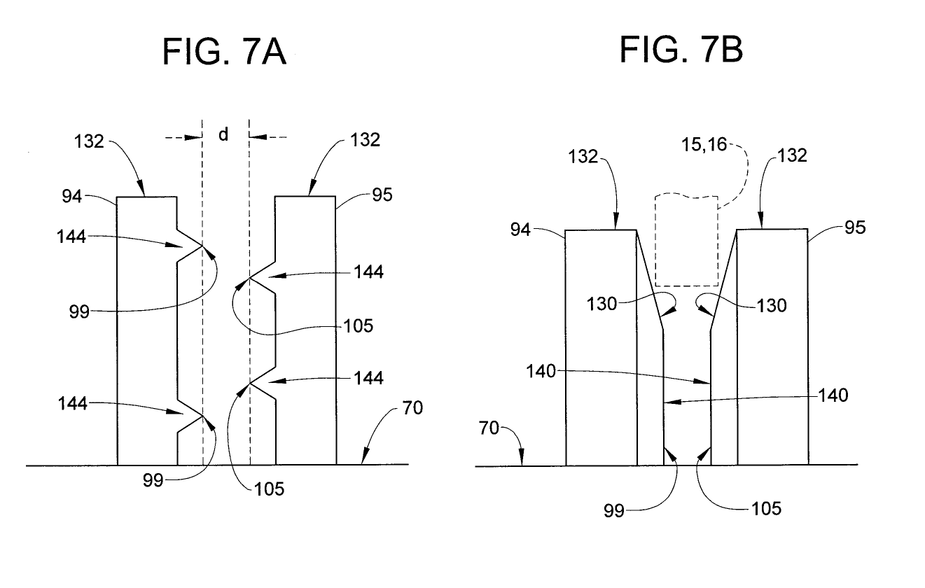

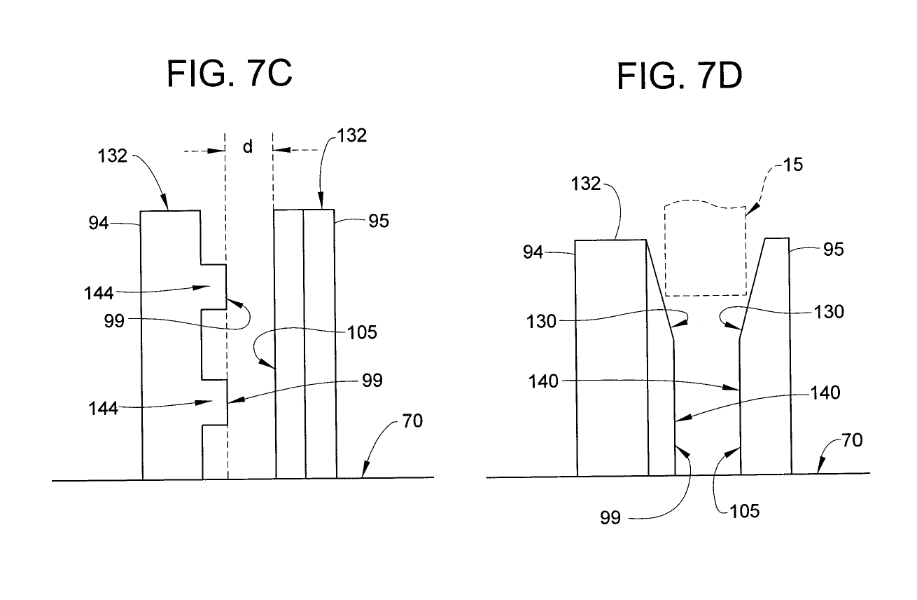

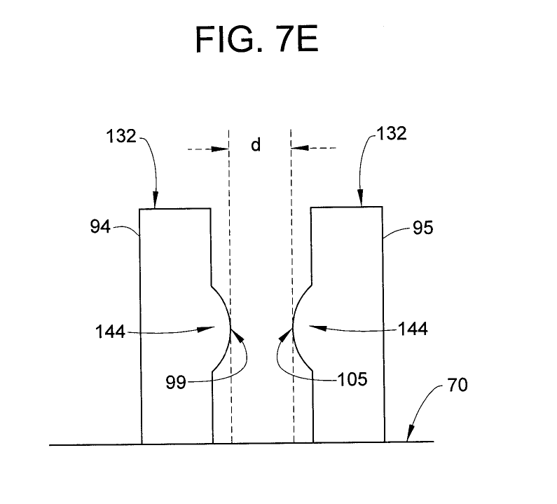

Referring again to FIGS. 4 and 5, in one embodiment at least one of the first engagement surface 99 or the second engagement surface 105, is disposed on a protrusion 144 that extends outwardly from at least one of the receiver walls 76, 77. The embodiment illustrated includes two of the protrusions 144 that are integrally formed with and from the same material as the deformable receiver walls 76, 77. The receiver walls 76, 77 are elastically deformable and are substantially flexible in comparison to the wall members 15, 16. As shown in FIGS. 7A-7E, in other embodiments the at least one protrusion 144 includes a plurality of the protrusions 144.

Referring to FIGS. 7A-7E, the protrusion 144, or plurality of protrusions 144, may have any suitable cross-sectional profile, or combination of cross-sectional profiles. These may include substantially triangular (FIGS. 7A and 7B), rectangular (FIGS. 4, 5, 7C and 7D) or arc-shaped (FIG. 7E), such as semicircular, semielliptical, parabolic or hyperbolic cross-sectional profiles, or a combination thereof. The cross-sectional profile of the protrusions 144 may be used, together with the other features of the invention described herein, to control the engagement characteristics of the first engagement surface 99 and the second engagement surface 105 and, for example, affect the contact area and contact pressure of the wall members 15, 16 against the deformable receiver walls 76, 77 and control the sliding friction and insertion force required to insert the plurality of wall members 15, 16 into the respective deformable receiver walls 76 and 77 and the clamping force of the receivers 74, 75 against the wall members 15, 16. Also, a profile of the protrusions 144 from the free surface 132 to the surface 70, as shown in FIG. 6B, includes the taper angle (α) of the lead-in portions 130, the height (hₚ) of the substantially planar engagement portions 138 that may also be used to control the engagement characteristics of the first engagement surface 99 and the second engagement surface 105. These engagement characteristics can also affect the contact area and contact pressure of the wall members 15, 16 against the receiver walls 76, 77 and control the sliding friction and insertion force required. The engagement surfaces 99, 105 may also be designed to control the interference and contact of the receiver 74, 75 both during and following insertion, and particularly may be designed to take into consideration the amount and range of deflection of the receiver walls 76, 77 and to maintain contact between these walls 76, 77 and the faces 19, 21 of the corresponding wall members 15, 16.

Referring again to FIGS. 6A-7D, regardless of whether the receiver walls 76, 77 include a protrusion 144 or a plurality of protrusions 144, or not, the distance (d) that defines the interference with the thickness (t) of the wall member 15, 16 is measured between the engagement surfaces 99, 105. In the case where none of the protrusions 144 are incorporated (e.g. FIGS. 6A and 6B), it is the distance between the opposing planar engagement surfaces 140. In the case where protrusions 144 are incorporated (e.g. FIGS. 7A-7E), the distance (d) is defined by the innermost portions of the first engagement surface 99 and second engagement surface 105.

The embodiments disclosed allow an operator to methodically align the first component 5 relative to the second component 7. The alignment method includes positioning the at least one wall member 15, 16 of the first component 5 proximate the receiver 74, 75 of the second component 7. Then inserting the wall member 15, 16 between the receiver walls 76, 77 by moving the first component 5 toward the second component 7 and creating interference between the engagement surfaces 99, 105 and the faces 19, 21 while elastically deforming the receiver walls 76, 77. The elastic deformation of the receiver walls 76, 77 aligns the first component 5 relative to the second component 7 to obtain an elastically averaged predetermined position between the first component 5 and the second component 7. The method further includes attaching the first component 5 to the second component 7 once the first component 5 and the second component 7 are aligned in the predetermined position.

At this point it should be understood that the exemplary embodiments provide a system for aligning components 5, 7 that facilitates an elastic averaging of a final position. The elastic averaging of the final position accommodates differences in manufacturing tolerances that could lead to a less than desirable appearance. Specifically, the elastic averaging alignment system 2 provides a better fit and finish between mating components/surfaces. Further, it should be understood that the receivers 74, 75 may frictionally retain corresponding wall members 15, 16 to aide in mounting the first component 5 to the second component 7.

Any suitable elastically deformable material may be used for the wall members 15, 16 and the receivers 74, 75. The term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Numerous examples of materials that may at least partially form the components include various metals, polymers, ceramics, inorganic materials or glasses, or composites of any of the aforementioned materials, or any other combinations thereof. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS), such as an ABS acrylic. The material may be in any form and formed or manufactured by any suitable process, including stamped or formed metal, composite or other sheets, forgings, extruded parts, pressed parts, castings, or molded parts and the like, to include the deformable features described herein. The material, or materials, may be selected to provide a predetermined elastic response characteristic. The predetermined elastic response characteristic may include, for example, a predetermined elastic modulus.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastic averaging alignment system, comprising:
a first component having at least one wall member defining a thickness between opposing faces thereof; and
a second component having a component surface with at least one receiver protruding therefrom, each of the at least one receiver having a first receiver wall with a first engagement surface and a second receiver wall with a second engagement surface, the first and the second engagement surfaces being positioned a distance apart less than the thickness such that at least one of the first and the second receiver walls elastically deform in response to the at least one wall member being positioned between the first and the second receiver walls.

2. The elastic averaging alignment system of claim 1, wherein the at least one wall member comprises a plurality of wall members each having a first longitudinal axis that is substantially parallel to one another and the at least one receiver comprises a plurality of receiver walls corresponding to the plurality of spaced apart wall members.

3. The elastic averaging alignment system of claim 2, wherein at least one of the plurality of wall members extends along a second longitudinal axis, the second longitudinal axis being oriented in a non-parallel relationship to the first longitudinal axis.

4. The elastic averaging alignment system of claim 3, wherein the plurality of wall members includes a plurality of spaced apart wall members extending along the second longitudinal axes that are substantially parallel to one another.

5. The elastic averaging alignment system of claim 4, wherein the plurality of wall members include a freestanding wall attached to the first component on a first end and an opposed second end.

6. The elastic averaging alignment system of claim 3, wherein the at least one wall member includes a plurality of spaced apart wall members some extending along the first longitudinal axis and some extending along the second longitudinal axis.

7. The elastic averaging alignment system of claim 3, wherein the second longitudinal axis is substantially perpendicular to the first longitudinal axis.

8. The elastic averaging alignment system of claim 1, wherein at least one of the first engagement surface or the second engagement surface protrudes from its respective receiver wall.

9. The elastic averaging alignment system of claim 1, wherein the first engagement surface is on at least one protrusion from the first receiver wall or the second receiver wall.

10. The elastic averaging alignment system of claim 9, wherein the at least one protrusion is a plurality of protrusions.

11. The elastic averaging alignment system of claim 9, wherein the at least one protrusion has a substantially triangular, rectangular or an arc-shaped cross-sectional profile, or a combination thereof.

12. The elastic averaging alignment system of claim 1, wherein at least one of the first engagement surface or the second engagement surface includes a lead-in portion that tapers inwardly from a free first end of the receiver wall with which it is associated toward the opposing engagement surface.

13. The elastic averaging alignment system of claim 12, wherein the lead-in portion adjoins a planar engagement portion of the respective engagement surface that extends substantially perpendicular from the component surface.

14. A method of aligning a first component with a second component, the first component comprising at least one wall member having a thickness between opposing faces and extending along a first longitudinal axis, the second component comprising a component surface and at least one receiver being elastically deformable and protruding from the component surface, each receiver comprising a first receiver wall protruding from the component surface having a first engagement surface and an opposing second receiver wall extending from the component surface having a second engagement surface, the first engagement surface spaced from and opposing the second engagement surface by a distance that provides an interference condition between the first and second engagement surfaces and the opposing faces of the at least one wall member such that the first and second receiver walls elastically deform upon insertion of the at least one wall member between the first and second engagement surfaces, comprising:
positioning the at least one at least one wall member of the first component proximate the at least one receiver of the second component;
inserting the at least one wall member between the first and second receiver walls by moving a free end of the at least one wall member toward the component surface and creating the interference condition between the first and second engagement surfaces and the opposing faces of the at least one wall member;
elastically deforming at least one of the first and second receiver walls; and
aligning the first component relative to the second component by elastic deformation of the first and second receiver walls to obtain an elastically averaged position of the first component relative to the second component.

15. The method of claim 14, further comprising attaching the first component to the second component once the first component and second component are in the elastically averaged position.

16. The method of claim 14, wherein the at least one wall member comprises a plurality of spaced apart first wall members, first longitudinal axes of the first wall members being substantially parallel to one another, and further comprising at least one second wall member extending along a second longitudinal axis, the second longitudinal axis being oriented in a non-parallel relationship to the first longitudinal axes, and wherein the at least one receiver comprises a plurality of spaced apart receiver walls corresponding to the plurality of spaced apart first wall member and the at least one second wall member.

17. A motor vehicle trim alignment system comprising:
a first trim component comprising at least one wall member having a thickness defined between opposing faces and extending along a first longitudinal axis; and
a second trim component comprising a component surface and at least one receiver protruding from the component surface, each receiver comprising a first receiver wall protruding from the component surface having a first engagement surface and an opposing second receiver wall member extending from the component surface having a second engagement surface, the first engagement surface spaced from and opposing the second engagement surface by a distance that provides an interference condition between the first and second engagement surfaces and the opposing faces of the at least one wall member and configured to elastically deform the first and second receiver walls upon insertion of the at least one wall member between the first and second engagement surfaces to establish an elastically averaged position of the first trim component to the second trim component.

18. The motor vehicle trim alignment system of claim 17, wherein the first trim component comprises a door handle and the second trim component comprises a door panel.

19. The motor vehicle trim alignment system of claim 17, wherein the at least one wall member comprises a plurality of spaced apart wall members, the first longitudinal axes of the wall members being substantially parallel to one another and the at least one receiver comprises a plurality of spaced apart receivers corresponding to the plurality of spaced apart wall members.
